(19) United States
(12) Patent Application Publication
(10) Pub. No.: US 2019/0153876 A1
(43) Pub. Date: May 23, 2019

(54) NANOSTRUCTURE BETWEEN PLIES OF HIGH TEMPERATURE POLYMER MATRIX COMPOSITE

(71) Applicant: General Electric Company, Schenectady, NY (US)

(72) Inventors: Gregory Carl Gemeinhardt, Park Hills, KY (US); Thomas Michael Sutter, Cincinnati, OH (US)

(21) Appl. No.: 15/818,954

(22) Filed: Nov. 21, 2017

(51) Int. Cl. F01D 5/28; F01D 25/00; C08K 3/04; B32B 27/34

(52) U.S. Cl. CPC F01D 5/282; F01D 25/005; F05D 2300/603; B32B 27/34; C08K 3/041

(57) ABSTRACT

A high temperature polymer composite includes nanocomposite material, such as carbon nanotubes, dispersed in polymer matrix composite resin interlayer region, which may include bismaleimide or polyamide resin, between fiber containing plies. The nanocomposite material may be in an operating temperature in a range between 400-800 degrees Fahrenheit. Gas turbine engine parts or components such as airfoils, stator vanes, casings, and ducts may be made of the high temperature polymer composite.

### BACKGROUND OF THE INVENTION

### Technical Field

The present invention relates generally to polymer matrix composite parts and, more specifically, to nanostructures such as nanotubes in polymer matrix composites.

### Background Information

Polymer matrix composites incorporating carbon nanostructure, such as nanotubes, are known and have been suggested for use in machines such as gas turbine engines. United States Patent Application 2017/0234160 discloses a facing sheet for a fan casing comprising a support layer that includes a set of partitioned cavities with open faces and a facing sheet comprising a polymer matrix composite having a nanostructure. The fan casing is in a cold section of the engine. Hotter engine sections provide more difficult environments for parts or articles to operate in. Parts or articles operating in hot environments are subject to long term thermal exposure which can reduce durability and performance.

Polymer matrix composite parts operating in hot environments are subject to resin cracking due to thermal and thermal-oxidative resin degradation due to thermal cycling. High temperature polymer matrix composites for operating in a temperature range of 400-800 degrees fahrenheit are highly desirable. Composite resins, such as bismaleimide and polyamide, are particularly useful in this temperature operating range.

It is desirable to impede crack propagation and reduce the difference in coefficient of thermal expansion (CTE) between the composite resin and fiber in the polymer matrix composite (PMC) parts to minimize the cracking and/or damage due to thermal cycling. It is desirable to mitigate formation of resin microcracks and slow or stop the thermal degradation of the PMC material.

### SUMMARY OF THE INVENTION

A high temperature polymer composite includes nanocomposite material dispersed in a polymer matrix composite resin interlayer region between fiber containing layers or plies. The nanocomposite material may be carbon nanotube. The resin interlayer region may include bismaleimide resin or polyamide resin. The nanocomposite material may be in an operating temperature in a range between 400-800 degrees Fahrenheit.

A gas turbine engine includes at least one part or component made of the high temperature polymer composite. The part or component may be an airfoil, a stator vane, a casing, or a duct. The part or component may having an operating temperature in a range between 400-800 degrees Fahrenheit.

### BRIEF DESCRIPTION OF THE DRAWINGS

The invention, in accordance with preferred and exemplary embodiments, is more particularly described in the following detailed description taken in conjunction with the accompanying drawings in which:

FIG. 1 is an enlarged cross-sectional view of an exemplary high temperature polymer composite with nanocomposite material dispersed in a PMC resin interlayer region between fiber containing layers or plies.

FIG. 2 is an enlarged cross-sectional view of an exemplary high temperature polymer composite with nanocomposite material dispersed in PMC resin interlayer regions between and parallel to fiber containing layers or plies illustrated in FIG. 1.

FIG. 3 is an enlarged cross-sectional view of an exemplary high temperature polymer composite with nanocomposite material dispersed in PMC resin interlayer regions between and perpendicular to fiber containing layers or plies illustrated in FIG. 1.

FIG. 4 is a schematic cross-sectional view illustration of a gas turbine engine having at least one component made of a high temperature polymer composite with nanocomposite material dispersed in PMC resin interlayer regions between fiber containing layers or plies.

### DESCRIPTION

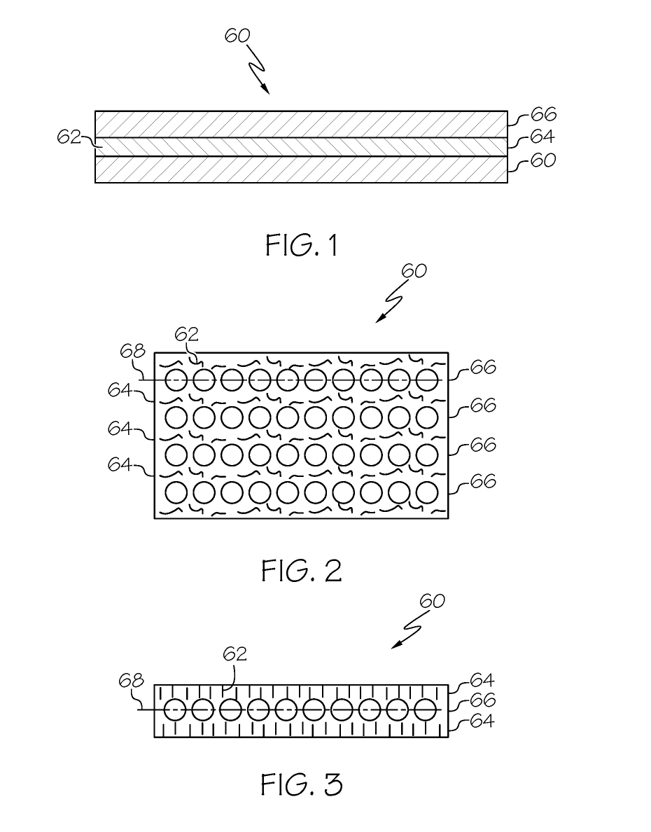

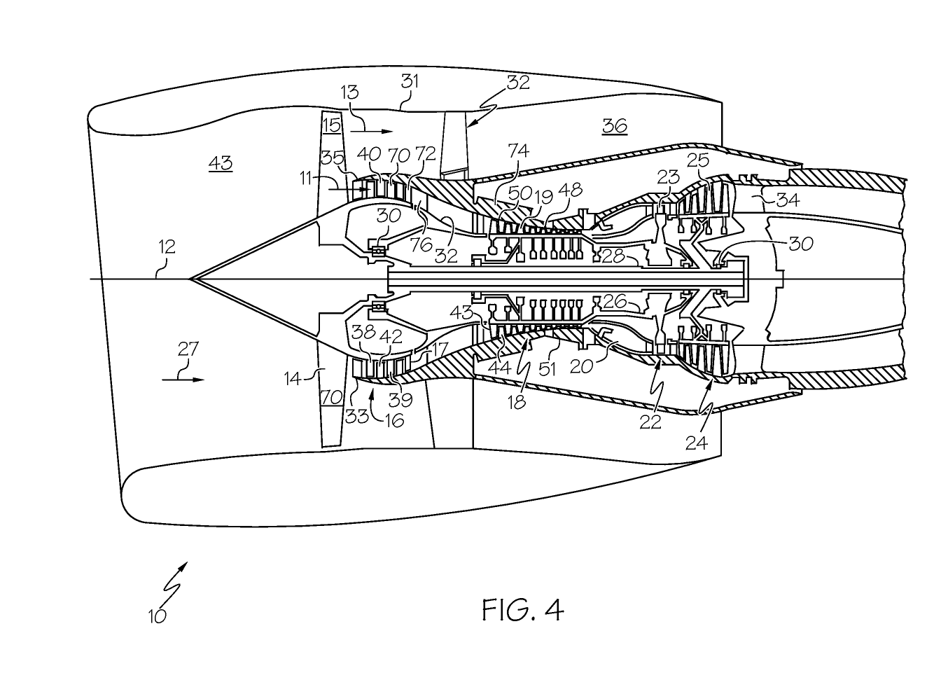

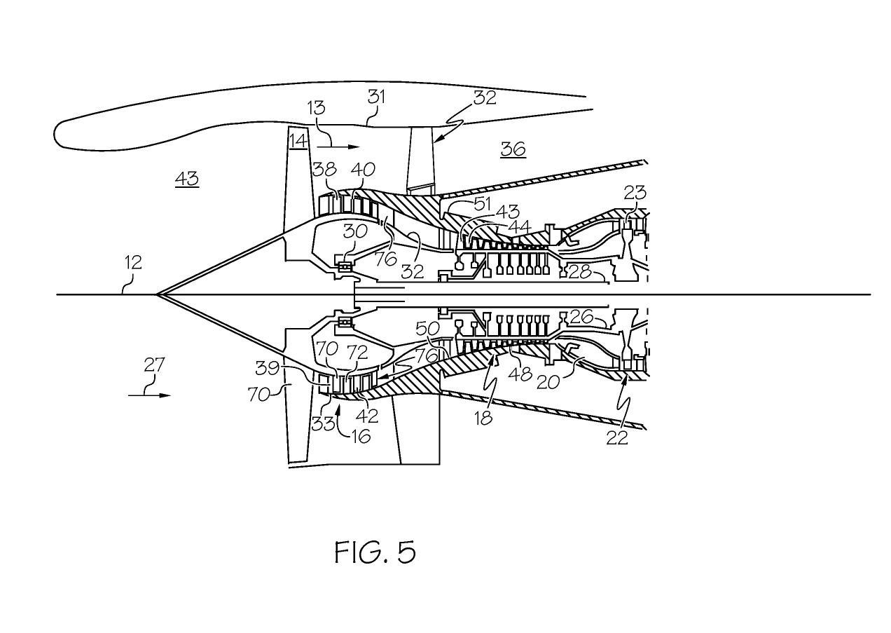

Illustrated in FIG. 1 is an exemplary high temperature polymer composite 60 with nanocomposite material 62 dispersed in a PMC resin interlayer region 64 between fiber containing layers or plies 66. The high temperature polymer composite 60 is suitable for use in a moderate high temperature or hot section of the gas turbine engine may be incorporated in a booster section 16 or a high pressure compressor section 18 of a gas turbine engine 10 illustrated in FIG. 4. High temperature polymer composite components provide cost and weight savings. The term composite has had several meanings regarding the use of two or more materials having different properties. More recently, in the aerospace industry, the term composite has come to be defined as a material containing a reinforcement such as fibers or particles supported in a binder or matrix material.

This polymer composite 60 operates to mitigate the formation of resin microcracks and slow or stop the thermal degradation of the PMC material. The carbon nanotube and/or carbon nanofiber materials 62 in the PMC resin interlayer regions 64 create a tortuous path that prevents or slows the formation and propagation of resin cracks and provides the additional advantages that they can increase the interlaminar strength of the composite and reduce the difference in coefficient of thermal expansion (CTE) between the fiber and matrix materials.

The exemplary polymer composite 60 material disclosed herein is made up of at least 3 discrete materials resin, fiber, and nanotubes. The construction of the composite is a traditional combination of resin and fiber reinforcement, with the addition of the nanotubes within the resin layer. The resin can be a variety of chemistries with a particular interest being bismaleimide and polyamide for the high temperature operating conditions. The fiber can be glass or carbon and in the form of uni-directional fibers or woven into any number of fabric or braid styles. The nanotubes can be introduced into the composite by a variety of methods including but not limited to the following:
1. dispersion into the resin prior to making the laminate,
2. as a separate film that is laid between plies,
3. grown onto the carbon fiber surfaces prior to making the laminate.

The nanotubes can also be aligned in a number of directions such as parallel to a plane 68 of the ply 66 as illustrated in FIGS. 2 and 3, perpendicular to the plane 68 of the ply 66 as illustrated in FIG. 3, or random. Carbon fiber angle or direction can vary between each layer or ply, but is illustrated herein in all the same direction for simplicity. Additionally, the nanotubes can be introduced in between every ply in the composite laminate through the thickness or located just between the outermost plies to provide surface level protection.

Illustrated in FIG. 4 is a gas turbine engine 10 having at least one part or component made of the nanocomposite material 62 illustrated in FIGS. 1-3. High temperature polymer composites are particularly suited for use in the booster and compressor stages of a commercial engine, and the fan and bypass sections of a military engine (since they often run hotter than commercial engines). Exemplary parts or components include airfoils, stator vanes, casings, ducts, and other parts of these engine sections or stages. Types of composite resins that may be particularly useful for high temperature polymer composites include bismaleimide and polyamide. They are suitable for use in an operating temperature in a range between 400-800 degrees Fahrenheit because they operate to mitigate the formation of resin microcracks and slow or stop the thermal degradation of the PMC material. The carbon nanotube and/or carbon nanofiber materials 62 in the PMC resin interlayer regions 64 create a tortuous path that prevents or slows the formation and propagation of resin cracks and provides the additional advantages that they can increase the interlaminar strength of the composite and reduce the difference in coefficient of thermal expansion (CTE) between the fiber and matrix materials.

The engine 10 is circumscribed about a longitudinal centerline or axis 12. The engine 10 includes, in downstream serial flow relationship, a fan section 14, booster section 16, high pressure compressor section 18, combustor section 20, high pressure turbine section 22, and low pressure turbine section 24. An outer shaft 26 drivingly connects a high pressure turbine 23 to a high pressure compressor 19. An inner shaft 28 drivingly connects the low pressure turbine 25 to a fan 15 and booster 17. The inner and outer shafts 28, 26 are rotatably mounted in bearings 30 which are mounted in a fan frame 32 and a turbine rear frame 34.

A flow splitter 35 surrounding the booster section 16 downstream of the fan section 14 includes a sharp leading edge 33 which splits the fan air 27 pressurized by the fan section 14 into a radially inner stream (core airflow 11) channeled through the booster section 16 and a radially outer stream or bypass airflow 13 is channeled through a bypass duct 36 spaced radially outwardly from the booster section 16. A fan casing 31 surrounding the fan section 14 and the bypass duct 36 is supported by an annular fan frame 32 circumscribed about the centerline 12.

The booster section 16 includes alternating annular row of booster blades and vanes 38, 42 extending radially outwardly and inwardly across a booster flowpath 39 in a booster duct 40. The annular row of booster blades 38 are suitably joined to the fan 15. The high pressure compressor 19 includes alternating annular row of compressor blades and vanes 43, 44 extending radially outwardly and inwardly across a compressor flowpath 48 in a compressor duct 50 surrounded by a compressor casing 51.

The high temperature polymer composites 60 may be used in the booster section 16 and the high pressure compressor 19 particularly in commercial engines and in the fan section 14 and the bypass duct 36 of military engines. Exemplary parts or components in these sections of the engine include airfoils 70, stator vanes 72, casings 74, ducts 76, and other parts of these engine sections or stages.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention.

Accordingly, what is desired to be secured by Letters Patent of the United States is the invention as defined and differentiated in the following claims:

What is claimed is:

1. A high temperature polymer composite comprising nanocomposite material dispersed in a polymer matrix composite resin interlayer region between fiber containing layers or plies.

2. The polymer composite as claimed in claim 1, further comprising the nanocomposite material being carbon nanotube.

3. The polymer composite as claimed in claim 1, further comprising the resin interlayer region including bismaleimide resin or polyamide resin.

4. The polymer composite as claimed in claim 3, further comprising the nanocomposite material being in an operating temperature in a range between 400-800 degrees Fahrenheit.

5. The polymer composite as claimed in claim 3, further comprising the nanocomposite material being carbon nanotube.

6. The polymer composite as claimed in claim 5, further comprising the nanocomposite material being in an operating temperature in a range between 400-800 degrees Fahrenheit.

7. A gas turbine engine comprising at least one part or component made of a high temperature polymer composite including nanocomposite material dispersed in a polymer matrix composite resin interlayer region between fiber containing layers or plies.

8. The gas turbine engine as claimed in claim 7, further comprising the nanocomposite material being carbon nanotube.

9. The gas turbine engine as claimed in claim 7, further comprising the resin interlayer region including bismaleimide resin or polyamide resin.

10. The gas turbine engine as claimed in claim 9, further comprising the nanocomposite material being carbon nanotube.

11. The gas turbine engine as claimed in claim 7, further comprising the at least one part or component having an operating temperature in a range between 400-800 degrees Fahrenheit.

12. The gas turbine engine as claimed in claim 11, further comprising the nanocomposite material being carbon nanotube.

13. The gas turbine engine as claimed in claim 11, further comprising the resin interlayer region including bismaleimide resin or polyamide resin.

14. The gas turbine engine as claimed in claim 13, further comprising the nanocomposite material being carbon nanotube.

15. The gas turbine engine as claimed in claim 7, further comprising the at least one part or component being chosen from the group comprising: airfoils, stator vanes, casings, and ducts.

16. The gas turbine engine as claimed in claim 15, further comprising the nanocomposite material being carbon nanotube.

17. The gas turbine engine as claimed in claim 15, further comprising the resin interlayer region including bismaleimide resin or polyamide resin.

18. The gas turbine engine as claimed in claim 17, further comprising the nanocomposite material being carbon nanotube.

19. The gas turbine engine as claimed in claim 15, further comprising the at least one part or component having an operating temperature in a range between 400-800 degrees Fahrenheit.

20. The gas turbine engine as claimed in claim 19, further comprising the nanocomposite material being carbon nanotube.

21. The gas turbine engine as claimed in claim 19, further comprising the resin interlayer region including bismaleimide resin or polyamide resin.

22. The gas turbine engine as claimed in claim 21, further comprising the nanocomposite material being carbon nanotube.
